(19) United States
(12) Patent Application Publication
(10) Pub. No.: US 2005/0100476 A1
(43) Pub. Date: May 12, 2005

(54) Chemical processing system and method

(76) Inventors: Andrew De Mello, Middlesex (GB); Michael C. Mitchell, Muswell Hill (GB)

Correspondence Address: Warner Norcross & Judd;Intellectual Property Practice Group, 900 Fifth Third Center, 111 Lyon street NW, Grand Rapids, MI, 49503-2487, US

(21) Appl. No.: 10/363,928

(22) PCT Filed: Sep. 13, 2001
(86) PCT No.: PCT/GB01/04112

(30) Foreign Application Priority Data
Sep. 13, 2000 (GB) 00224378

(51) Int. Cl. B01L 3/00

(52) U.S. Cl. 422/68.1; 422/103; 422/100

(57) ABSTRACT

A chemical processing system and method, the system comprising: a substrate chip including a reaction zone into which at least three different reagents are in use introduced; a reagent supply mechanism for supplying the at least three reagents to the reaction zone; and a detector for simultaneously detecting the reaction products.

The present invention relates to a chemical processing system and method, in particular, but not exclusively, a miniaturised synthesis and total analysis system (μSYNTAS) for the chemical synthesis and analysis of compound libraries.

Combinatorial chemistry is used increasingly in synthetic chemistry because of the ability to synthesise large numbers of compounds, referred to as compound libraries, in a practical time frame, which compounds can then be screened, for example, for biological activity.

One such chip-based chemical processing system for use in combinatorial chemistry is disclosed in the applicant's earlier GB-A-2319771. In this chemical processing system, first and second flows of reactants are introduced serially through separate inlet ports into a reaction chamber and the products of those reactions are directed through an outlet. By delivering the reactants in at least one of the first and second flows at predetermined time intervals, the reactions are time encoded such that the products of the reactions can be separated and correlated to the reactants.

Whilst this chip-based chemical processing system allows for the synthesis of compound libraries, the serial introduction of the reactants requires there to be a predetermined time interval between the introduction of each different reactant in order to avoid cross-contamination and thus constrains the rate of compound synthesis.

It is thus an aim of the present invention to provide a chip-based chemical processing system and related method which allow for more rapid chemical processing, in particular the synthesis of compound libraries.

Accordingly, the present invention provides a chemical processing system, comprising: a substrate chip including a reaction zone into which at least three different reagents are in use introduced; a reagent supply mechanism for supplying the at least three reagents to the reaction zone; and a detector for simultaneously detecting the reaction products.

In the context of the present invention the term reagent is to be understood as encompassing reagent precursors. In one example, an active reagent, for example a catalytic species, may be formed in situ typically by activation or transformation.

Preferably, the substrate chip includes a plurality of inlet ports through which the at least three reagents are delivered to the reaction zone.

More preferably, the substrate chip includes a plurality of inlet ports through which the at least three reagents are separately delivered to the reaction zone.

Preferably, the substrate chip includes an outlet through which the reaction products are in use are directed.

In one embodiment the detector comprises a mass spectrometer.

Preferably, the mass spectrometer comprises a time-of-flight mass spectrometer.

In another embodiment the detector is an nmr mass spectrometer.

Preferably, the reagent delivery mechanism is configured to deliver the reagents as liquid flows.

More preferably, the reagent delivery mechanism is configured to deliver the reagents continuously or as plugs of predeterminable volume at predeterminable times in liquid flows.

Still more preferably, the reagent delivery mechanism is configured to control the flow rates of the liquid flows.

The present invention also provides a chemical processing method, comprising the steps of: delivering at least three different reagents to a reaction zone in a substrate chip; and simultaneously detecting the reaction products of the multiple reactions.

Preferably, the at least three reagents are delivered to the reaction zone through a plurality of inlet ports.

More preferably, the at least three reagents are delivered to the reaction zone through separate inlet ports.

Preferably, the reaction products are directed from the reaction zone through an outlet port.

In one embodiment the reaction products are detected by mass spectrometry.

Preferably, the reaction products are detected by time-of-flight mass spectrometry.

In another embodiment the detection is by nmr spectrometry.

Preferably, the reagents are delivered as liquid flows.

More preferably, the reagents are delivered continuously or as plugs of predeterminable volume at predeterminable times in liquid flows.

Still more preferably, the flow rates of the liquid flows are controlled.

In a preferred embodiment, by providing for multiple reactions in a single reaction chamber and the simultaneous analysis of the resulting products, much increased high-throughput reaction screening and compound library synthesis can be provided. Further, the on-line analysis of reagents and reaction products avoids the need for preparative or work-up chemistries, providing a route towards automated, high-throughput solution-phase combinatorial chemistry.

The present invention has many potential applications, but one of the most significant is as a component of a μSYNTAS. Arrays of microdevices could feasibly be used for the synthesis, derivatisation and subsequent analysis of products with extremely high throughput capacity. As the pharmaceutical industry moves towards the development of drugs “tailored” to specific population genotypes, so-called pharmacogenomics (Ref 5), the synthesis and screening of large numbers of structurally-related molecules gains ever-greater importance. Arrays of ρSYNTAS devices would provide a route towards the automation of such processes.

A preferred embodiment of the present invention will now be described hereinbelow by way of example only with reference to the accompanying drawings, in which:

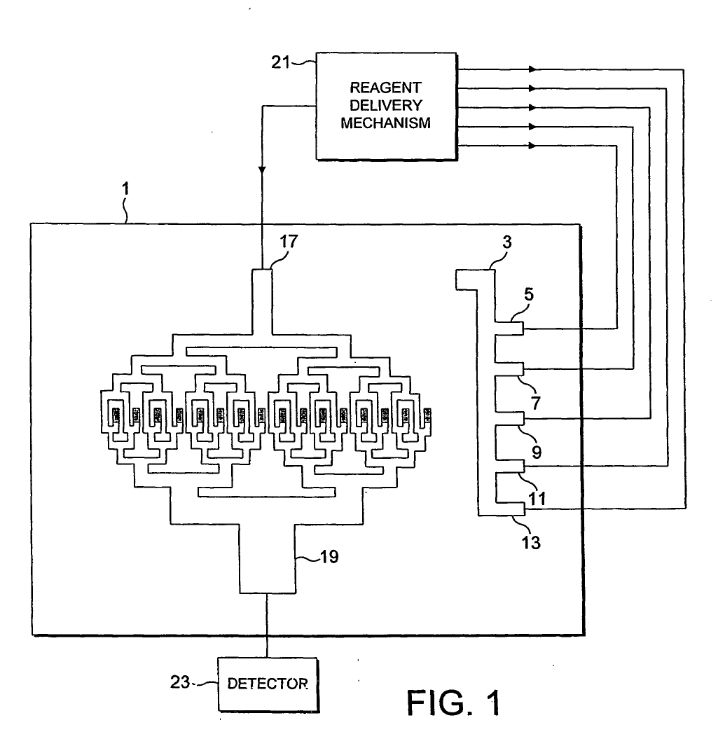

FIG. 1 schematically illustrates the chip layout of the microfabricated chip of a chemical processing system in accordance with a preferred embodiment of the present invention;

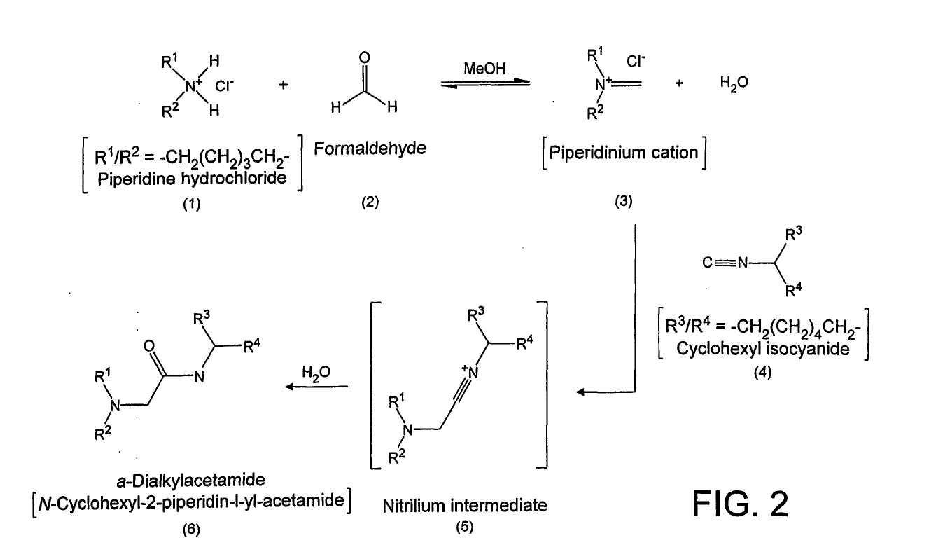

FIG. 2 illustrates the Ugi four-component condensation reaction;

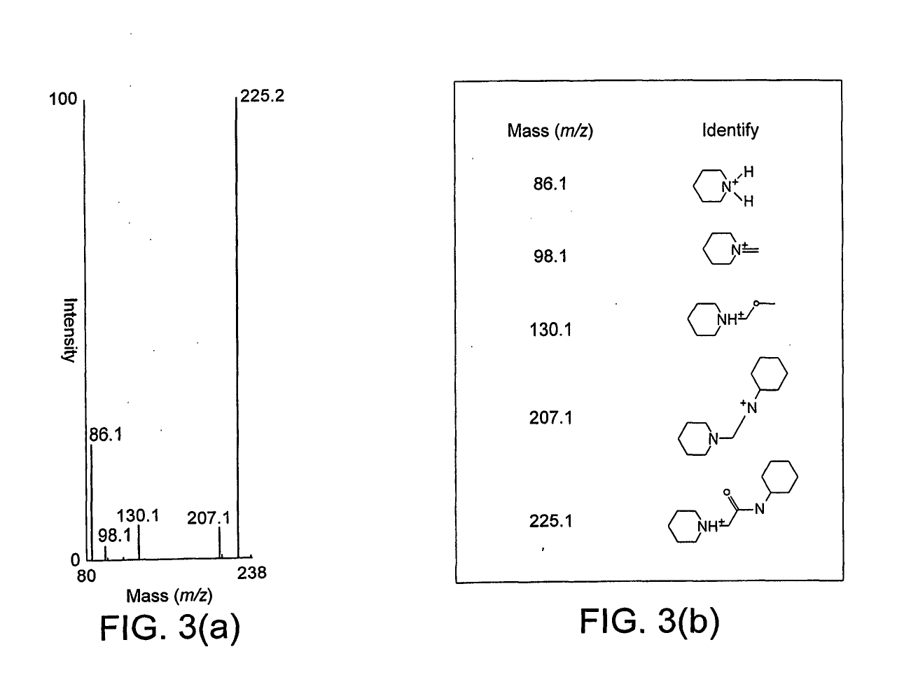

FIG. 3(a) illustrates the mass spectrum detected for the reaction of FIG. 2;

FIG. 3(b) illustrates starting reagents and intermediates as determined from the mass spectrum of FIG. 3(a);

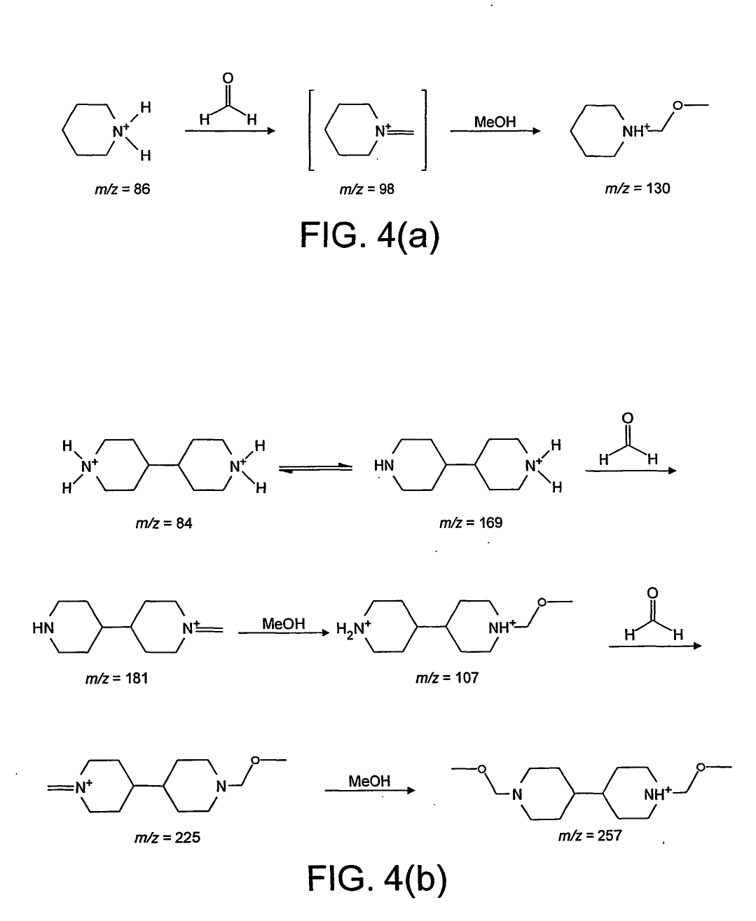

FIG. 4(a) illustrates the reaction of piperidine hydrochloride with formaldehyde;

FIG. 4(b) illustrates the reaction of 4,4′-biperidine dihydrochloride with formaldehyde;

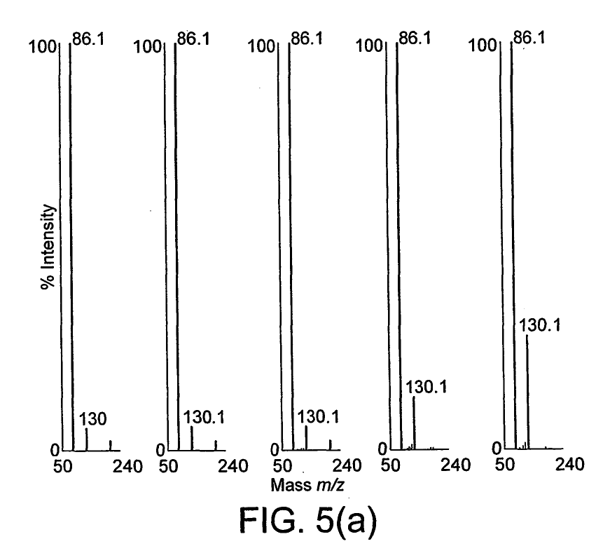

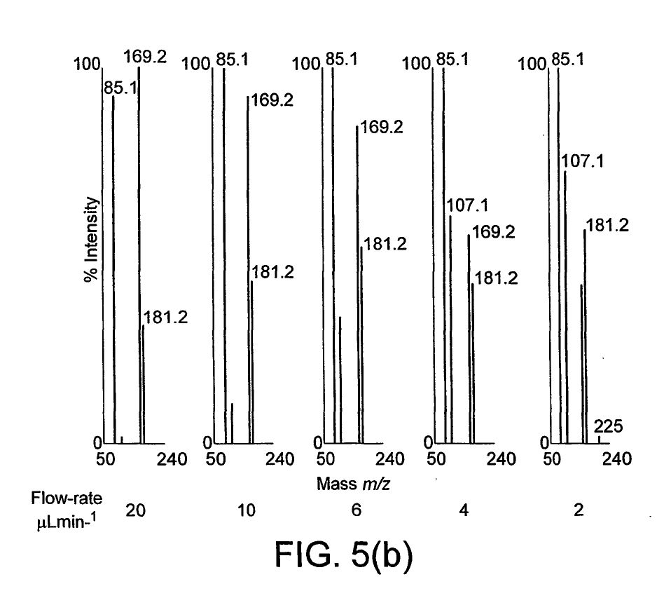

FIG. 5(a) illustrates the mass spectrum detected for the reaction of FIG. 4(a) for flow rates in the range of 20 to 2 μLmin⁻¹;

FIG. 5(b) illustrates the mass spectrum detected for the reaction of FIG. 4(b) for flow rates in the range of 20 to 2 μLmin⁻¹;

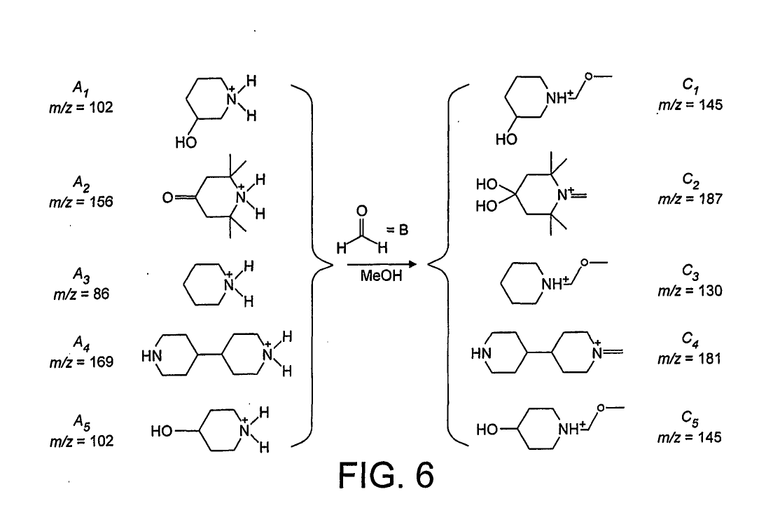

FIG. 6 illustrates the reactions of five secondary amine hydrochloride salts with a methanol solution of formaldehyde; and

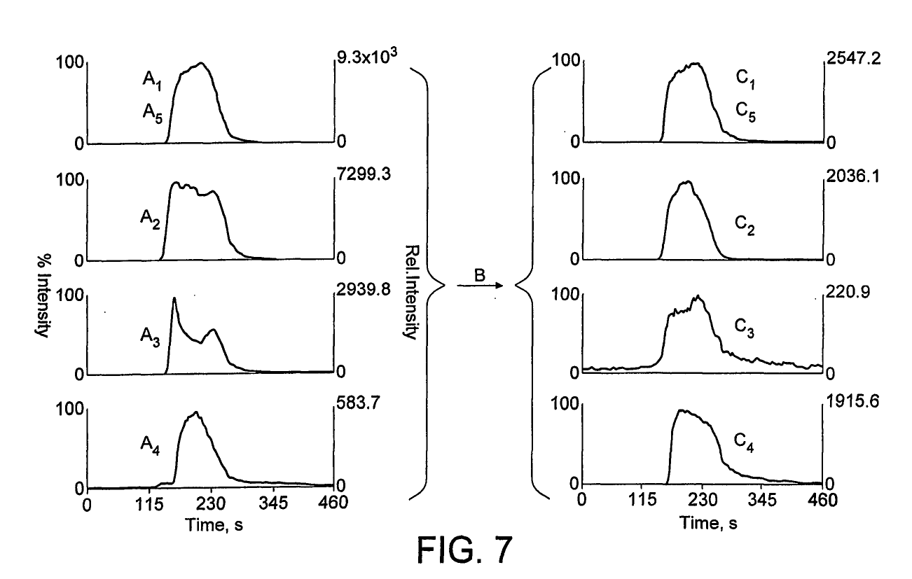

FIG. 7 illustrates the mass spectrum detected for the reactions of FIG. 6 when reacted simultaneously.

FIG. 1 illustrates a microfabricated chemical processing system in accordance with a preferred embodiment of the present invention as fabricated in a substrate chip 1.

The chip 1 includes a first inlet channel 3 which includes a plurality, in this embodiment first to fifth, inlet ports 5, 7, 9, 11, 13, through which reagents are in use delivered, and is split into a plurality, in this embodiment sixteen, partial flows (not illustrated), and a second inlet channel 15 which includes an inlet port 17 through which a reagent is in use delivered, with the partial flows of the first and second channels 3, 15 being respectively connected to provide for distributive mixing of the reagent flows through the first and second inlet channels 3, 15. In this embodiment the reagents can either be delivered continuously or as plugs injected into one or more solvent flows using commercially available rheodyne injection valves. By controlling the injection times and volumes of reagent plugs and the flow rates of the solvent flows, fine control of the reactions in the reaction zone can be obtained. Further control of the reactions in the reaction zones can be obtained by control of the temperature of the reaction zone and the application of radiation, for example light, of different intensity and/or frequency.

The chip 1 further includes an outlet channel 19 which includes an outlet port 21 through which flows the reaction products.

In this embodiment the chip 1 is fabricated from first to third bonded plates, with the central plate being a silicon wafer and having the inlet and outlet channels 3, 15, 19 defined therein, and the outer plates being Pyrex™ wafers and including the inlet and outlet ports 5, 7, 9, 11, 13, 17, 19.

The chemical processing system further comprises a reagent delivery mechanism 21 for delivering the reagents to the inlet channels 3, 15, a detector 23, in this embodiment a mass spectrometer, for detecting the reaction products, and a controller (not illustrated) for controlling the operation of the reagent delivery mechanism 21 and the detector 23. In a preferred embodiment the mass spectrometer is a time-of-flight (TOF) mass spectrometer. In another embodiment the detector could be an nmr spectrometer.

The chemical processing system can be used with many reaction types, such as metal-catalysed coupling, cycloaddition, polymerization, and oxidation or reduction chemistries. For the purposes of illustration, however, the operation of the chemical processing system will be described with reference to a multi-component reaction (MCR) as first reported by Ugi et al (Ref 1). On account of the pharmaceutical relevance of the products obtained, MCRs have become accepted as a valuable part of the synthetic toolkit of combinatorial chemistry (Refs 2 and 3).

MCRs rely upon the fact that a certain reaction sequence occurs only when all of the relevant components are mixed, with the products obtained being multi-functional in nature, and the variation of one or more of the reagents leading to the rapid formation of many closely related products within a compound library. MCRs represent an ideal model reactions for parallel-mode compound synthesis as typically from three to six reagents are required for an MCR, resulting in the production of compound libraries having great complexity.

One example of an MCR is illustrated in FIG. 2. It has been suggested (Ref 4) that this Ugi four-component condensation (4 CC) reaction initially involves the production of an iminium species (3) followed by the attack of cyclohexylisocyanide (4) to yield a nitrilium cation intermediate (5) which rapidly produces the final α-dialkylacetamide product (6). When performed on a typical laboratory-scale, the reaction is reported as proceeding in a highly exothermic “violent” manner (Refs 1 and 4).

One mode of operation of the chemical processing system will now be described. In a first step, at room temperature, a continuous flow of a solvent is delivered through the first and second inlet ports 5, 7 of the first inlet channel 3 at a flow rate of 10 μLmin⁻¹ and a continuous flow of a methanol solution of formaldehyde (0.20 M) is delivered through the inlet port 17 of the second channel 15 at the same flow rate. In a second step, the remaining MCR components of the Ugi four-component condensation reaction, namely piperidine hydrochloride and cyclohexylisocyanide, are delivered at a ratio of 0.1:1 from an injection loop (50 nL) into the first inlet 5 of the first inlet channel 3. These reagents, which when mixed with the methanol solution of formaldehyde delivered through the second inlet channel 15, yield the MCR product of α-dialkylacetamide (6) which is caused to flow through the outlet channel 19. The outlet flow is analysed on-line by the detector 23 and requires no batch collection or purification steps.

FIG. 3(a) illustrates the mass spectrum detected by the detector 23. The detailed information yielded by the mass spectrum illustrates the power and sensitivity of the chemical processing system for chemical synthesis. The [M+H]⁺ ion for N-cyclohexyl-piperidin-1-yl-acetamide (m/z=225.2) is clearly observed as the major reaction product. A series of starting reagents and reaction intermediates are also observed as identified in FIG. 3(b). The fact that the desired reaction product is obtained in such excess is a surprise as this particular reaction is typically carried out at reduced temperature (0° C.) in ‘bench-top’ preparation. The intensity of the α-dialkylacetamide signal may be explained by consideration of the thermal characteristics of the microreactor. The dimensions of the inlet and outlet channels 3, 15, 19 are such as to provide very high surface area to volume ratios which results in fast thermal transfer within the microreactor environment to such an extent that even an exothermic reaction such as the Ugi four-component condensation reaction does not raise the local temperature significantly. Consequently, by-product formation is limited, principally observed as two peaks at m/z 239 and 417 (not illustrated), and the product α-dialkylacetamide is dominant. Such behaviour has great implications for enabling the control of highly exothermic or endothermic reactions by performing those reactions on a microfluidic platform.

Another mode of operation of the chemical processing system will now be described. In this mode, the reaction of both piperidine hydrochloride (see FIG. 4(a)) and 4,4′-biperidine dihydrochloride (see FIG. 4(b)) with a methanol solution of formaldehyde is dynamically controlled in the range of total flow rates of from 20 to 2 μLmin⁻¹. In both these reaction systems, as illustrated by the mass spectra of FIGS. 5(a) and (b), a reduction in the flow rate results in an increased intensity of the respective reaction products relative to the starting reagents. Indeed, the use of TOF mass spectrometry allows the course of the complex reaction of 4,4′-bipiperidine dihydrochloride with the methanol solution of formaldehyde to be followed very closely. A variety of singly and doubly-charged products and by-products are observed, the peak intensities of which can be altered by flow rate control. Thus, this chemical processing system enables one product to synthesised in favour of another, thereby offering a route to automated, high-yielding chemical syntheses. The on-line nature of the coupling between synthesis and analysis steps is clearly a significant development in the progress towards a microfabricated system capable of reaction optimisation.

Another mode of operation of the chemical processing system will now be described. In this mode, as illustrated in FIG. 6, five secondary amine hydrochloride salts A₁-A₅ are reacted simultaneously with a methanol solution of formaldehyde B, with a continuous flow of each of the reagents being delivered at a flow rate 3 μLmin⁻¹ into respective ones of the first to fifth inlet ports 5, 7, 9, 11, 13 of the first inlet channel 3 and a continuous flow of formaldehyde being delivered at the same flow rate into the inlet port 17 of the second inlet channel 15. These reagents, which when mixed with the methanol solution of formaldehyde delivered through the second inlet channel 15, yield the reaction products C₁-C₅ which are caused to flow simultaneously through the outlet channel 19. The outlet flow is analysed on-line by the detector 23 and requires no batch collection or purification steps. As illustrated in the mass spectra of FIG. 7, despite the reagents be delivered simultaneously, the peaks corresponding to the unreacted amine salts A₁-A₅ and the reaction products C₁-C₅ can be clearly resolved by their corresponding m/z ratios with the exception, of course, of the isomeric reagents A₁, A₅ and isomeric products C₁, C₅. Indeed, comparison of the determined mass spectra for these parallel-mode reactions with the mass spectra for the same reactions performed in serial mode indicates the presence of no additional product peaks, thus confirming that there is minimal cross-reaction between the reagents in parallel mode reaction.

Finally, it will be understood that the present invention has been described in its preferred embodiment and can be modified in many different ways without departing from the scope of the invention as defined by the appended claims.

### REFERENCES

Ref 1 I. Ugi, R. Meyr, C. Fetzer, C. Steinbückner, Agnew. Chem. 71, 386 (1959).
Ref 2 R. W. Armstrong, A. P. Combs, P. A. Tempest, S. D. Brown, T. A. Keating, Acc. Chem. Res. 29, 123-131 (1996).
Ref 3 N. K. Terrett, Combinatorial Chemistry, Oxford Chemistry Masters (Oxford University Press, Oxford, 1998).
Ref 4 I. Ugi, S. Lohberger, R. Karl, Comprehensive Organic Chemistry, B. M. Trost, I. Fleming, Eds. (Pergamon, New York, 1991), vol. 2, 1083-1109.
Ref 5 Nature Biotechnology 16, 1-21 (1998).

1. A chemical processing system, comprising:
a substrate chip including a reaction zone into which at least three different reagents are in use introduced;
a reagent supply mechanism for supplying the at least three reagents to the reaction zone; and
a detector for simultaneously detecting the reaction products.

2. The system of claim 1, wherein the substrate chip includes a plurality of inlet ports through which the at least three reagents are delivered to the reaction zone.

3. The system of claim 2, wherein the substrate chip includes a plurality of inlet ports through which respective ones of the at least three reagents are delivered to the reaction zone.

4. The system of any of claims 1 to 3, wherein the substrate chip includes an outlet through which the reaction products are in use are directed.

5. The system of any of claims 1 to 4, wherein the detector comprises a mass spectrometer.

6. The system of claim 5, wherein the mass spectrometer comprises a time-of-flight mass spectrometer.

7. The system of any of claims 1 to 4, wherein the detector is an nmr mass spectrometer.

8. The system of any of claims 1 to 7, wherein the reagent delivery mechanism is configured to deliver the reagents as liquid flows.

9. The system of claim 7, wherein the reagent delivery mechanism is configured to deliver the reagents continuously or as plugs of predeterminable volume at predeterminable times in liquid flows.

10. The system of claim 9, wherein the reagent delivery mechanism is configured to control the flow rates of the liquid flows.

11. A chemical processing method, comprising the steps of:
delivering at least three different reagents to a reaction zone in a substrate chip; and
simultaneously detecting the reaction products of the multiple reactions.

12. The method of claim 11, wherein the at least three reagents are delivered to the reaction zone through a plurality of inlet ports.

13. The method of claim 12, wherein the at least three reagents are delivered to the reaction zone through separate inlet ports.

14. The method of any of claims 11 to 13, wherein the reaction products are directed through an outlet.

15. The method of any of claims 11 to 14, wherein the detection is by mass spectrometry.

16. The method of claim 15, wherein the detection is by time-of-flight mass spectrometry.

17. The method of any of claims 11 to 14, wherein the detection is by nmr spectrometry.

18. The method of any of claims 11 to 17, wherein the reagents are delivered as liquid flows.

19. The method of claim 18, wherein the reagents are delivered continuously or as plugs of predeterminable volume at predeterminable times in liquid flows.

20. The method of claim 19, wherein the flow rates of the liquid flows are controlled.
